(19) United States
(12) Patent Application Publication
(10) Pub. No.: US 2010/0176131 A1
(43) Pub. Date: Jul. 15, 2010

(54) LOCKING SYSTEM AND A FLASK COMPRISING A LOCKING SYSTEM

(76) Inventors: Joaquim Lopez Leon, Rua Joaquim Nabuco (BR); Julio Cesar Legramanti Neves, Sao Paulo (BR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/063,539

(22) PCT Filed: Aug. 14, 2006
(86) PCT No.: PCT/BR06/00160

§ 371 Date: May 22, 2008

(30) Foreign Application Priority Data
Aug. 23, 2005 (BR) PI0503738-7

(51) Int. Cl. B65D 45/00; E05C 19/00

(52) U.S. Cl. 220/315; 292/2

(57) ABSTRACT

The present invention relates to a locking system, particularly designed for flasks that comprise a set of containers that fit by the neck, wherein there is the need for a quite effective closure to ensure tightness.

The system comprises a fitting neck associated to a container, wherein, when the flask is closed, there is contact between a lock and a counterlock, and further between a first and a second release projections and a first and a second fitting recess.

Further, the present invention relates to flasks that comprise the locking system described above.

### FIELD OF THE INVENTION

The present invention relates to a locking system particularly intended for flasks comprising a set of containers fittable by the neck, such as flasks with profiles, packages with internal containers for preventing direct contact with the packed product, flasks with configurations designed for isolation, among others, wherein there is a need for a quite effective closure, ensuring tightness.

Further, the present invention relates to flasks comprising the above-mentioned locking system.

### DESCRIPTION OF THE PRIOR ART

Flasks for cosmetic products such as anti-aging and moisturizing products are well known, wherein the flask comprises a container formed with a neck provided with an outer thread, onto which an internally-threaded cap is applied. The user unscrews the cap, takes a portion of the product and applies it.

An evident problem encountered in flasks of this type is that a good closure will not be achieved if the user does not tighten the cap sufficiently. In order to prevent this problem, it would be advantageous for the user to notice easily that the closure has been successfully effected.

Further, with the frequent use of the product packed in the flask, one can notice alteration in said product due to the exchange of heat between the user's hands and the article, which may impair its cosmetic action.

The applicant will indicate, hereinafter, the relevant prior-art documents related to the matter of the present invention.

Document EP 544557 describes a flask of circular base, coupled to a solid base made of a translucent material. Flasks of this type are intended for packing cosmetic products. The circular base engages with the inner wall of the solid base. A locking system to keep the flask closed is not seen.

Document EP 635223 describes a dispenser for products such as creams for cosmetic or pharmaceutical use that comprises an external body with an open bottom and a container containing a packed product to be inserted or removed through this bottom. A locking system to keep the flask closed is not seen either.

Document U.S. Pat. No. 5,099,998 describes a container comprising another internal container with an internal cover, an external container and with an external cover. Each of these containers has a maximum packing capacity. These objects are intended for storage and transportation of dangerous materials.

From the description of the present description hereinafter one can conclude that no prior-art teaching proposes advantages referring to the ease of handling (opening and closing) the flask of the present invention, ensuring the tightness thereof.

### OBJECTIVES OF THE INVENTION

The present invention aims at solving the problems encountered in closing flasks that comprise containers, providing the user with greater ease in handling it.

### SUMMARY OF THE INVENTION

The invention relates to a container locking system comprising:
a fitting neck formed from a fitting projection having an inner surface;
a container having a shaping wall with a first outer sur-face and a reinforcement bead;
at least one lock positioned along the first outer surface of the shaping wall;
at least one counterlock positioned along the inner surface of the fitting projection;
at least one release projection located at the reinforce-ment bead;
at least one fitting recess located in the fitting projection;
the container being associated by fitting the fitting neck through interference association between the lock and the counterlock, the fitting recess (24) being engaged with the release projection (10); and
the container (1) being unlocked by exerting a force onto the release projection (10), deforming the shaping wall (11) so that the lock (14) and the counterlock (25) will come out of the interlocking condition.

Further, the present invention relates to a flask provided with a container and a fitting neck that comprises the container locking system mentioned above.

### BRIEF DESCRIPTION OF THE FIGURES

The present invention will now be described in greater detail with reference to the embodiment represented in the drawings. The figures show:

FIG. 1 is a perspective view of a first embodiment of the container comprised in the flask of the present invention;

Detail 1 is a sectional view of a detail of the first embodiment of the container comprised in the flask of the present invention;

FIG. 2 is a perspective view of a first embodiment of the body comprised in the flask of the present invention;

Detail 2 is a sectional view of a detail of the first embodiment of the body comprised in the flask of the present invention;

FIG. 3 is a perspective view of a second embodiment of the container comprised in the flask of the present invention;

Detail 3 is a sectional view of a detail of the second embodiment of the container comprised in the flask of the present invention;

FIG. 4 is a perspective view of a second embodiment of the body comprised in the flask of the present invention;

Detail 4 is a sectional view of a detail of the second embodiment of the body comprised in the flask of the present invention;

FIG. 5 is a sectional view in the longitudinal section of the flask of the present invention assembled;

FIG. 6 is a sectional view of a detail of the flask of the present invention illustrated in FIG. 5; and

FIG. 7 is a sectional view of a detail of the flask of the present invention illustrated being assembled.

### DETAILED DESCRIPTION OF THE INVENTION

The present invention describes a locking system, particularly designed for flasks that comprise a set of refill-type containers 1 fittable to fitting necks 20 for this purpose, wherein there is a need for a quite effective closure, ensuring tightness.

The system comprises a fitting neck 20 associated to a container 1, wherein, when the flask is closed, there is contact between a lock 14 and a counterlock 25 and still between a first and a second release projection 10 and a first and a second fitting recess 24.

Examples of products that may be packed in the flask of the present invention are:
Cosmetic products such as: anti-aging products; creams in general; moisturizers; exfoliants; firming products; anti-spot preparations; localized-action cosmetic preparations, for example for treating spots and shades under the eyes;
Pharmaceutical products like: pharmaceutical preparations for topical application; anti acne products;
Other products having a creamy or gel consistency.

The flask and the locking system of the present invention have a range of advantages and characteristics desired in products of this type, some of which are listed below:

by virtue of the fact that the flask of the present invention comprises a container 1 that is fittable into a body 2, it becomes feasible to use refills easily; only a refill with the same dimension will be needed to replace the container 1;

since it is possible to use refills with the flask of the present invention, the cost for the user is then lower;

further, there are products, especially in the cosmetology area, that undergo alterations due to the heat from the hands in contact with the flask in which the product is packed; so the validity of such a product would be reduced; by using the flask of the present invention, one prevents direct contact of the hands with the container 1 in which the product is packed, thus prolonging the validity time of the product;

a locking system comprising elements that interact by interference and further elements that remain in contact with the closed flask has high efficacy in the closure of the flask, preventing incidental spillage of the packed product;

further, due to the high efficacy of the system, the action of external agents that might get into the flask is minimized; thus, the ideal characteristics of the packed products are maintained for a longer period of time;

the container 1 and the body 2 comprised in the flask may have varied shapes; thus, the possibilities of shaping and combinations between these parts are many, providing different models, so as to satisfy all tastes of the user;

due to the elements that constitute the locking system, the flask is easy to close, requiring quite simple movements of the user;

the flask of the present invention has a strong commercial and marketing appeal, by virtue of its modern look;

the user can open the flask of the present invention by using only one hand.

### Flask

The flask of the present invention is constituted by at least one container 1 and a body 2. Further, the flask may contain a cover (not shown). The cover may be constituted preferably by a plastic film or a metallic film.

### Container

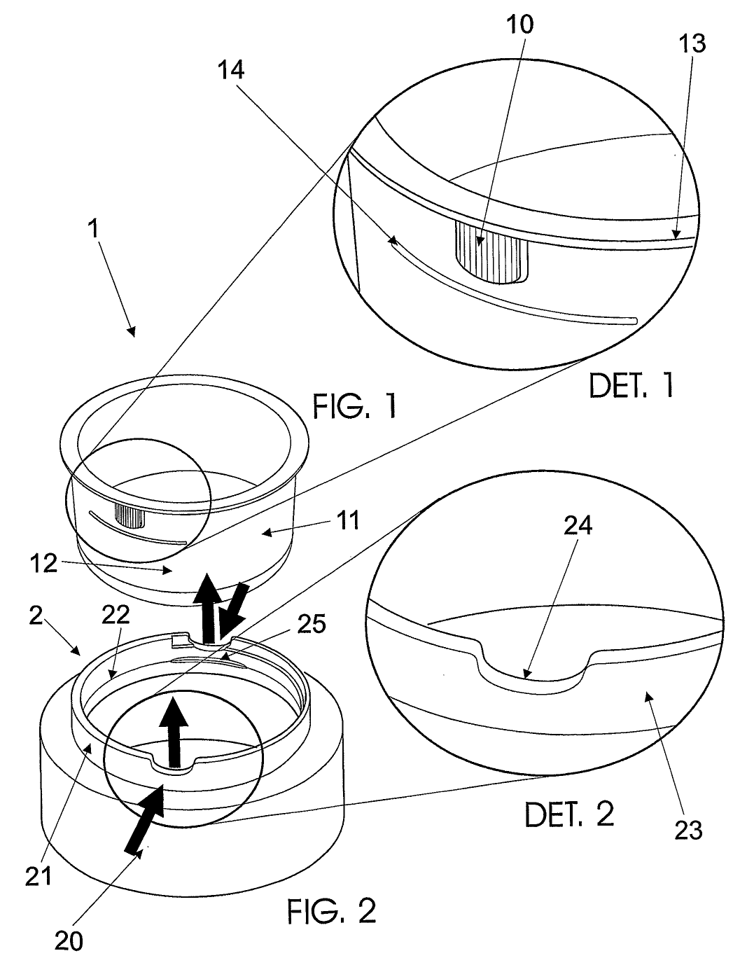

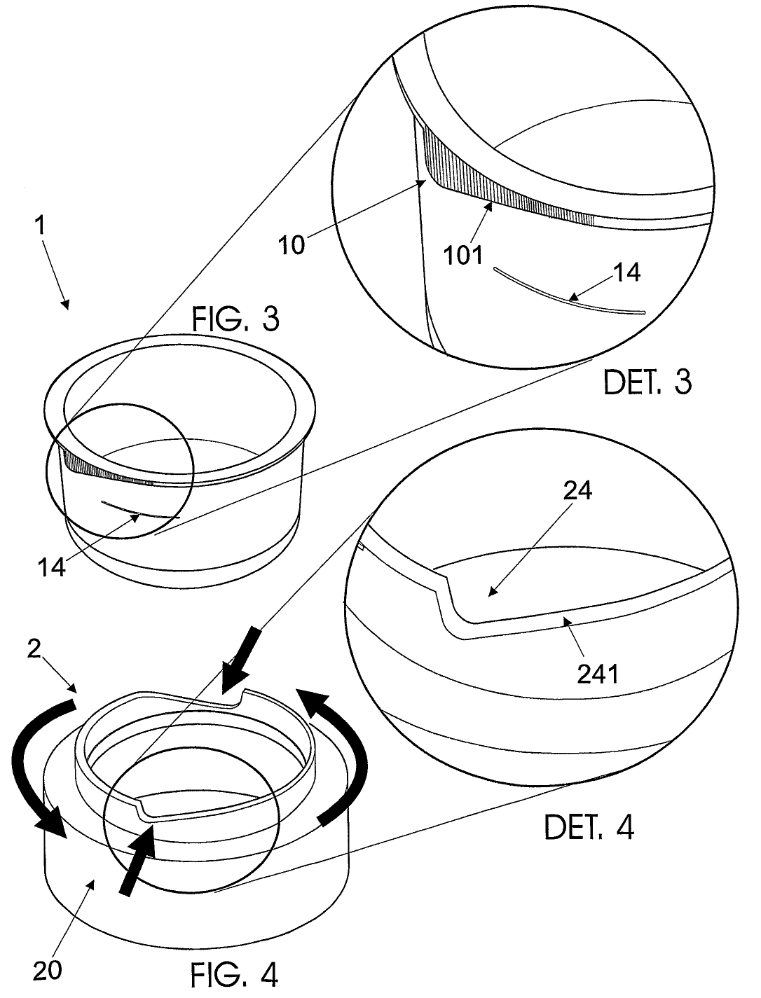

As can be seen in FIGS. 1 and 3, the container 1 is formed basically by a shaping wall 11, by preference substantially cylindrical in shape, having a preferably circular base that is associated to the shaping wall and still a first outer surface 12. Alternatively, the base may have other shapes, for instance, concave, convex, among others, provided that it has a cross-section such as to be associable to said shaping wall 11, preferably at its lower portion.

A lock projection 14 is located on the first outer surface 12 of the shaping wall 11 of the container. Preferably, this lock projection 14 is constituted by a salience having a length much longer than its width and that is arranged on the shaping wall in a direction parallel to the base, that is to say, at the perimeter.

The container 1 comprises at least one lock projection 14, but preferably two lock projections 14 arranged symmetrically. The container 1 may further contain more than two lock projections 14, as desired.

At the upper portion of the shaping wall 11, that is to say, opposite the base, there is a reinforcement bead 13, which is a ring, the smaller diameter of which is in conformity with the diameter of the cross-section of the shaping wall 11, and the larger diameter may vary as desired. The ring-shaped bead 3 is parallel to the cross-section of the shaping wall 11.

As can be seen in the details 1 and 3, there is at lest one release projection 10 perpendicular to the reinforcement 13 and, therefore, parallel to the shaping wall 11. This release projection 10 should always be in harmony with the lock projection 14. The release projection 10 is constituted by a projection that may have different shapes, as for example a “C” shape, or a triangular shape, and still may comprise ribs to facilitate the handling by the user.

Further, the release projection 10 may comprise a first sliding plane 101 at its lower portion, as illustrated in detail 3. This sliding plane 101 performs the function of fitting the container 1 into the body 2 in the case of the second preferred embodiment of the present invention.

### Body

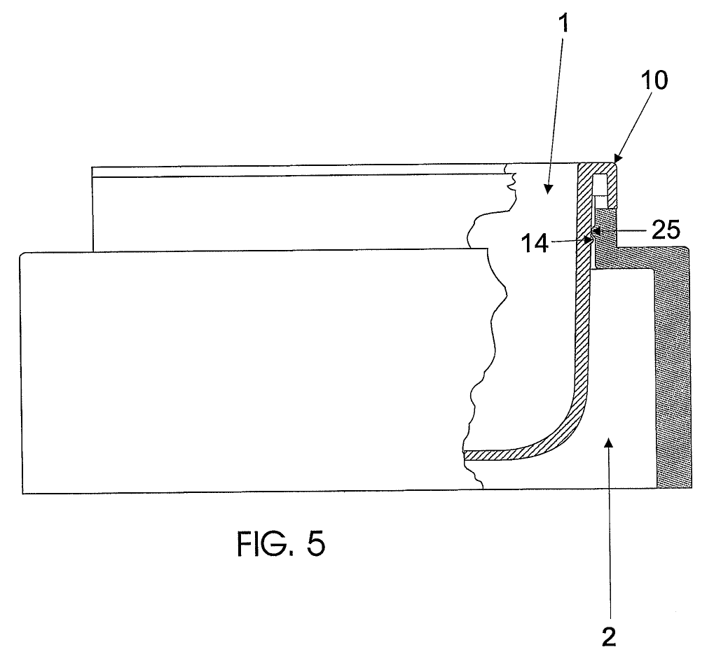

As can be seen in FIGS. 2 and 4, the body 2 is provided with at least one fitting neck 20 and a fitting projection 21. The fitting neck 20 is preferably cylinder shaped, and its height may vary. The shape of the fitting neck 20 may vary, as long as an external package for flasks is constituted and it has a supporting base. Further, its base may also have various shapes and it may even not exist. The fitting neck 20 may be opened at its lower portion.

At the upper portion of the fitting neck 20 there is a fitting projection 21, which is also preferably cylindrical with a height compatible with the height of the shaping wall 11 of the container 1 and comprises an inner surface 22 and a second outer surface 23. By preference, the cross-section of the fitting projection 21 has a diameter smaller than the diameter of the cross-section of the fitting neck 20. The fitting projection 21 may comprise a thread arranged on the second outer surface 23 around the whole fitting projection 21.

Further, as can be seen in details 2 and 4, at the upper portion of the fitting projection 12 there is a fitting recess 24, which is a cut-out, preferably C-shaped or triangular. This fitting recess 24 is associable to the release projection 10 of the container 1. Thus, in preferred embodiments of the present invention the fitting projection 21 comprises two fitting recesses 24 arranged symmetrically, but may comprise more, according to the number of release projections 10 present on the container 1.

This fitting recess 24 comprises a second sliding plane 241, which refers to an inclined portion of the fitting recess, as illustrated in detail 4. This second sliding plane 241 has a shape in conformity with the first sliding plane 101, which will be described in detail later.

Further, with regard to the fitting projection 21, on the inner surface 22 there is at least one counterlock projection 25 in a shape compatible with the lock projection 14 present on the first outer surface 12 of the shaping wall 11 of the container 1. Therefore, the shaping projection 25 has the shape of a salience arranged perimetrally on the inner surface 22 of the fitting projection 21 and its length is much larger than its width. Further, in preferred embodiments, two symmetrically equal counterlack projections 25 are present on the inner surface 22.

### Locking

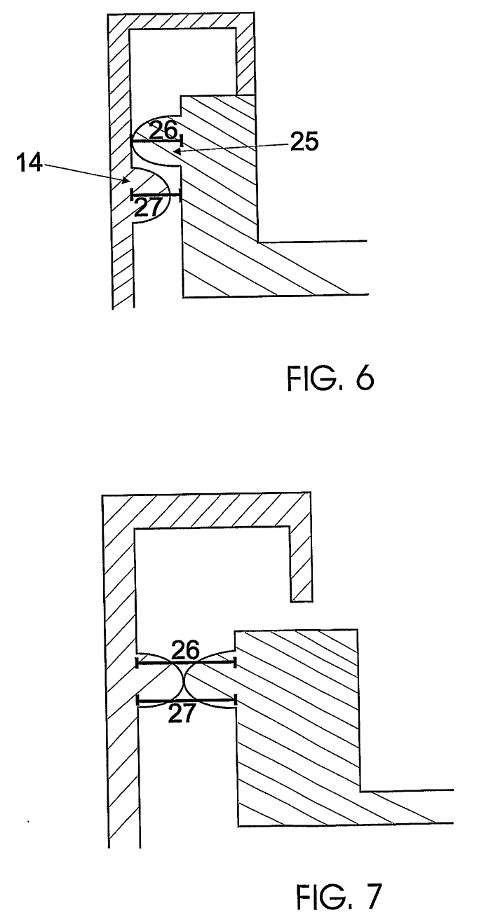

With the flask of the present invention assembled, as illustrated in FIGS. 5 and 6, one can see that the lock projection 14 has a first contact distance 26 between the shaping wall 11 and the fitting neck 20 with a value h₁, as can be seen in FIG. 6, an the counterlock projection 25 has a second contact distance 27 between the shaping wall 11 and the fitting neck 20 designated as h₂, h₁ and h₂ having the same magnitude and values close to each other.

When the flask is disassembled, that is to say, when the contact between the container 1 and the body 2 is undone, as can be seen in FIG. 7, due to the displacement of the lock projection 14 with respect to the counterlock projection 25, the first contact distance 26 is then called H1 and the second contact distance 27 is than called H₂, H₁ being greater than h₁, and H₂ being greater than h₂. In this way, the container 1 can be taken out of the body 2.

At a particular moment, when the lock projection 14 and the counterlock projection 25 are aligned with each other, as shown in FIG. 7, the values of H1 and H2 are identical.

### Locking System

### Assembling the Flask—First Embodiment

With regard to the embodiment of the present invention illustrated in FIGS. 1 to 4, in order to assemble the flask that comprises the container 1 and the body 2, one should fit the container 1 into the fitting projection 21 vertically. With the proximity of these parts, there will be a contact between the elements: lock projection 14, present on the first outer surface 12 of the shaping wall 11, and the counterlock 25, present on the inner surface 22 of the fitting projection 21.

The user should exert pressure onto the container 1 so that the shaping wall 11 will deform slightly, with its diameter being reduced at the place where the lock projection 14 is located. At this moment, as described before, the first and second contact distances 26 and 27 then have the values H₁ and H₂. In this way, the lock projection 14, which was over the counterlock projection 25, moves and will be under the counterlock projection 25. In this movement, the user may hear a characteristic sound of this type of fitting.

If this pressure is exerted, the container 1 will be secured to the fitting projection 21. Further, the release projection 10 will be harmonized with the fitting recess 24, since the two of them have a shape compatible for engaging each other. Further, at this moment, as described before, the first and second contact distances 26 and 27 will then have the values h₁ and h₂.

The assembled flask, comprising the container 1 and the body 2, can be seen in FIGS. 5 and 6.

### Disassembling the Flask—First Embodiment

In order to disengage the container 1 from the body 2, the user should exert a force onto the release projection 10, as if he were approximating one to the other. This force should be kept during the whole action of disengaging the container 1. This movement will cause the deformation of the shaping wall 11, causing the diameter of the places where the lock projections are to decrease slightly.

With the reduction of this diameter, the user can remove the container 1 from the body 2, since it is possible to undo the contact between the lack projection 14 and the counterlock projection 25.

When the container 1 detaches from the body 2, the user can stop the force exerted onto the release projection 10.

The result of this action can be represented in FIGS. 1 and 3.

### Assembling the Flask—Second Embodiment

With regard to the second embodiment of the present invention, illustrated in FIGS. 3 and 4, in order to assemble a flask comprising the container 1 and the body 2, one should fit the container 1 into the fitting projection 21, making a helical movement. With regard to the embodiment illustrated in said figures, the user should effect the movement of the container 1 in a sliding way, for instance, in clockwise direction, leaving the body 2 parallel. In this way, the first sliding plane 101 slides on the second sliding plane 241 in a relative helical movement between the container 1 and the body 2 until the fitting is completed. With the proximity of these parts, there will be contact between the elements: lock projection 14, present on the first outer surface 12 of the shaping wall 11, and the counterlock projection 25, present on the inner surface 22 of the fitting projection 21.

With the helical movement effected, the lock projection 14 fits under the counterlock projection 25.

Thus, the container 1 will be secured to the fitting projection 21. Further, the release projections 10 will be in contact with the fitting recesses 24, since these have a shape compatible for fitting.

Alternatively, just as in the previous embodiment, the user may exert pressure onto the container 1 so that the shaping wall 11 will deform slightly, and its diameter will be reduced at the place where the lock projections 14 are located. At this moment, as described before, the first and second contact distances 26 and 27 will now have the value H₁ and H₂. Thus, the lack projection 14, which was on the counterlock projection 25, moves and remains under the counterlock projection 25. In this movement, the user may hear a sound characteristic of this type of engagement.

By making this pressure, the container 1 will remain secured to the fitting projection 21. Further, the release projection 10 will be harmonized with the fitting recess 24, since the two of them have a compatible shape for fitting. Further, at this moment, as described before, the first and second contact distances 26 and 27 will now have the value h₁ and h₂.

The assembled flask, comprising the container 1 and the body 2 can be seen in FIGS. 5 and 6.

### Disassembling the Flask—Second Embodiment

In order to disengage the container 1 from the body 2, the user should make a movement in a direction contrary to the movement when assembling the flask, by holding the release projections 10, keeping the body 2 steady. This movement should be made through the action of disengaging the container 1. The action will entail deformation of the shaping wall 11, causing the lock projection 14 to be displaced, eliminating its contact with the counterlock projection 25.

In this way, the user can disengage the container from the body 2. The release projections 10 will slide on the fitting recesses 24 during the helical movement, until the container 1 is free from contact with the body 2.

When the container 1 disengages itself from the body 2, the user may stop the force exerted onto the release projections 10.

The result of this action may be represented in FIGS. 1 and 3.

Preferred embodiments having been described, one should understand that the scope of the present invention embraces other possible variations, being limited only by the contents of the accompanying claims, which include the possible equivalents.

1. A container locking system comprising:
a fitting neck formed from a fitting projection having an inner surface;
a container having a shaping wall with a first outer surface and a reinforcement bead;
at least one lock positioned along the first outer surface of the shaping wall;
at least one counterlock positioned along the inner surface of the fitting projection; and
at least one release projection located at the reinforcement bead;
the system being characterized in that:
at least one fitting recess is located in the fitting projection;
the container being associated by fitting the fitting neck through interference association between the lock and the counterlock, the fitting recess being engaged with the release projection; and
the container being unlocked by exerting a force onto the release projection, deforming the shaping wall so that the lock and the counterlock will come out of the interlocking condition.

2. A system according to claim 1, characterized in that at least one counterlock is positioned perimetrally along the inner surface of the fitting projection and at least one release projection is located perimetrally at the reinforcement bead.

3. A system according to claim 1, characterized in that the lock and the counterlock are positioned so that they will remain parallel to each other and in contact when the container is fitted into the fitting neck.

4. A system according to claim 1, characterized in that, when the flask is assembled, the first contact distance of the lock projection is h₁ and when the flask is disassembled the first contact distance of the projection is H₁, wherein H₁>h₁.

5. A system according to claim 1, characterized in that, when the flask is assembled, the second contact distance of the conterlock projection is h₂ and when the flask is disassembled, the contact distance of the conterlock projection is H₂, wherein H₂>h₂.

6. A system according to claim 1, characterized in that the fitting neck has a substantially tubular shape.

7. A system according to claim 1, characterized in that the container has at least one substantially tubular portion.

8. A system according to claim 1, characterized in that there are two release projections located at the reinforcement bead, and two fitting recesses located at the fitting projection.

9. A system according to claim 8, characterized in that the release projections are substantially C-shaped.

10. A system according to claim 8, characterized in that the release projections have a substantially triangular shape.

11. A system according to claim 10, characterized in that the first sliding plane slides over a second sliding plane in a relative helical movement between the container and the fitting neck until fitting is completed.

12. A system according to claim 10, characterized in that the container can be unlocked by a helical movement of the container with respect to the fitting neck.

13. A system according to claim 1, characterized in that the release projections comprise an outer surface having ribs.

14. A system according to claim 1, characterized in than the container comprises a concave base.

15. A system according to claim 1, characterized in that the container comprises a circular base.

16. A flask provided with a container and a fitting neck, characterized by comprising the container-locking system as defined in claim 1.

17. A flask according to claim 16, characterized by being intended for packing cosmetic products.

18. A flask according to claim 16, characterized by being intended for packing pharmaceutical products.
